(19) United States
(12) Patent Application Publication
(10) Pub. No.: US 2010/0253919 A1
(43) Pub. Date: Oct. 7, 2010

(54) METHOD AND SYSTEM FOR LASER PROJECTION AND HOLOGRAPHIC DIFFRACTION GRATING FOR A VEHICLE

(76) Inventor: RALPH PAUL DOUGLAS, Woodcliff Lake, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/704,916

(22) Filed: Feb. 12, 2010

Related U.S. Application Data
(60) Provisional application No. 61/207,513, filed on Feb. 13, 2009.

(51) Int. Cl. G03B 21/20; G03B 21/14

(52) U.S. Cl. 353/13; 353/121

(57) ABSTRACT

The present invention is a method and system for projecting an image from a vehicle onto a surface, such as a road or sidewalk. A laser diode assembly is installed in the vehicle and comprises: a light beam source; a power source; a power regulating chip; an image creation means; and, power activating means. A lens is secured to an output end of the laser diode assembly, and comprises a light diffraction image which can be a message, logo, or graphic design Activation is initiated by switching on the assembly from a position within the interior of the vehicle, or by an activity such as the opening of a door. The activation is ramped up to a full-on state over a pre-set period of time.

### CROSS REFERENCE TO RELATED APPLICATION

This application is related to, and claims priority from, U.S. Provisional Application Ser. No. 61/207,513 filed Feb. 13, 2009, the entire contents of which is incorporated herein by reference.

### BACKGROUND OF THE INVENTION

1. Field of the Invention

The present invention relates to a method and system for projecting an image from a vehicle onto a surface. More specifically, the present invention relates to a method and system of causing a laser generated beam of light to pass through a lens having an image thereon, and casting the image on a surface such as a road, curb, or vehicle appendage.

2. Description of the Related Art

The related art involves the lighting industry generally, and recreational or safety lighting in particular. The automotive industry has an extensive aftermarket or custom lighting culture. The use of inexpensive, packaged light emitting diodes (LEDs) in sheets, strips, or individually, have allowed car enthusiasts to add lighting to their vehicles to make a social statement or increase visibility.

The lighting used in vehicles (be they cars, vans or even boats) is limited to providing light only. In more complicated screens or display systems, LED type lighting can be used as backlighting. But, the use of light to directly project images onto a surface such as a road or curb has not occurred.

Light projection has made great strides in the field of hand-held projection devices. Products such as SHOWWX™, a laser pico projector, available from Microvision, Inc. of Redmond, Wash., allow the user to project a stored still image or video stream upon a surface.

What is not appreciated by the prior art is that light can be utilized to deliver, from a vehicle, a variety of messages to potential consumers. These messages can be simple logos such as that belonging to the vehicle manufacturer, safety markings which display a message on the street alongside the vehicle, or even more complicated moving images which can be used to create mood settings at parties or drive-ins.

Accordingly, there is a need for an improved method and system for projecting laser images from a vehicle onto a surface.

### ASPECTS AND SUMMARY OF THE INVENTION

An aspect of the present invention is to provide a method for projecting an image upon a street, curb, or other selected surface. The image can be a logo, message, or graphic image.

Another aspect of the present invention is to provide a means for establishing a safety or warning zone around the periphery of a vehicle.

And, another aspect of the present invention is to provide projection means, mounted within a vehicle, that are programmable or remotely controllable.

The present invention relates to a method and system for projecting an image from a vehicle onto a surface, such as a road or sidewalk. A laser diode assembly is installed in the vehicle and comprises: a light beam source; a power source; a power regulating chip; an image creation means; and, power activating means. A lens is secured to an output end of the laser diode assembly, and comprises a light diffraction image which can be a message, logo, or graphic design Activation is initiated by switching on the assembly from a position within the interior of the vehicle, or by an activity such as the opening of a door. The activation is ramped up to a full-on state over a pre-set period of time.

According to an embodiment of the present invention there is provided a method and system for projecting an image from a vehicle onto a surface, such as a road, sidewalk, or even the rim of one or more of the vehicle's wheels. The vehicle can be a: passenger car; taxi; truck; bus; train; motorcycle; airplane; or, the like.

The method comprises a number of steps which begin with installing a laser diode assembly in the vehicle. The laser diode assembly comprises: a light beam source; a power source; a power regulating chip; an image creation means; and, power activating means for causing the power to be introduced to the laser diode assembly so as to activate the light beam source. The laser diode assembly further comprises: a laser module; a spacer tube; a mounting plate; and, a retaining plate.

The method flow further comprises connecting a set of positive and negative current lead lines from the laser diode assembly to a power source of the vehicle. A lens is secured to an output end of the laser diode assembly, wherein the lens comprises a light diffraction image. The securing step further comprises the step of mounting the lens on a plate or grommet and fixedly securing the plate or grommet to the output end of the laser diode assembly. The lens must be removably secured so as to be easily replaceable

The laser diode assembly is activated so as to project a beam of light from the laser diode assembly through the image creation means. The light beam output operates within the range of 0 to 20 mW.

The image creation means receives the beam of light from the light beam source and allows the beam of light to pass through the image so as to project the image upon the desired surface. The light diffraction image itself can be a message, logo, or graphic design. The image creation means can comprise a micro-lithograph secured to the laser diode assembly, wherein the micro-lithograph comprises has an image thereupon. Or, the image creation means can comprise a collimated beam, generated by the laser diode assembly, and shining through a holographic diffraction grating.

It is important to note that the means for deriving the beam of light, though adaptable to a laser diode module, can be derived from: high intensity LEDs; bare die LEDs which are powered through thin film coatings and concentrated by various means known to the art; and, the like.

The installing step further comprises installing the laser diode assembly in a side view mirror assembly, or a door panel assembly, of the vehicle. The laser diode assembly could be mounted in any vehicle panel or area that allows the laser diode assembly to project the light diffraction image through an opening onto the selected surface. If the assembly is mounted in the side view mirror, then the assembly is secured to the inside of the mirror so as to project the image downward from a hole in the bottom portion of the side view minor. If the laser diode assembly has been mounted in a door panel, then the assembly is positioned so as to project the light diffraction image through an opening located in a bottom portion of the door panel and passing therethrough to the selected surface.

The activation step further comprises the step of initiating the activation by switching on the laser diode module from a position within the interior of the vehicle, or by the opening of a door, or operation at a select speed, or while in the “Park” mode. The activation is ramped up to a full-on state over a pre-set period of time. Power is directed from the vehicle power source to an inline regulator chip. The regulator chip then provides a voltage usable by the laser diode assembly. The power activating means operates so as to bring the light beam source up to full brightness from a zero state over a 2 second interval. A 10 second off-time is required in between start-ups of the power activating means for the zero state over a 2 second interval to occur.

In an alternative embodiment of the present invention, a self-contained, battery driven projection means is installed within a vehicle door panel, or other suitable body assembly so as to project a still image, or moving images, from the vehicle to a selected surface. The projection means is programmable, or remotely controllable from a cell phone, computer, or similar device.

The above, and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a perspective depiction of a laser projection assembly of the type compatible with the present invention.

FIG. 2A is a perspective depiction of a laser projection assembly having a lens with an image to be projected.

FIG. 2B is a perspective depiction of a laser projection assembly having a grommet mounted lens with an image to be projected.

FIG. 3 is a perspective depiction of a vehicle side view mirror casing with a laser projection assembly mounted in the interior.

FIG. 4 is a perspective depiction of a car door with a laser projection assembly mounted therein.

FIG. 5A is a schematic of a laser projection assembly mounted within a carrier mounted to the center cap of a wheel.

FIG. 5B is a schematic of the carrier of FIG. 5A mounted to the center cap of a wheel and projecting an image onto the rim of the wheel.

FIG. 6 is a perspective depiction of a clamp used to secure a laser projection assembly to motorcycle handlebars or to the frame.

FIG. 7 is a flowchart of the method flow of the present invention.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

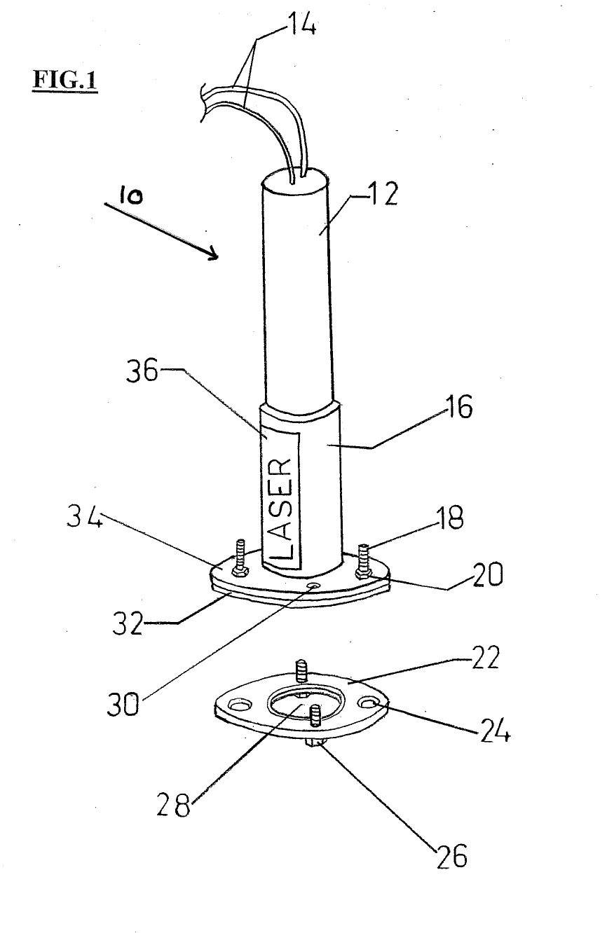

Turning to FIG. 1, there is shown a perspective depiction of a laser projection assembly 10 of the type compatible with the present invention.

The Laser assembly 10 has a laser module 12, with a safety label 36 affixed thereto, and powered through a set of negative and positive leads 14 connected to a regulator chip (not shown), which in turn is connected to the vehicle's power source. The laser module 12 is attached to a spacer tube 16 which sets the laser module 12 an optimal distance from the lens 28 (a micro lithograph) which has an image thereupon. The spacer tube 16 is attached to a mounting plate 34 and a corresponding protective composite gasket by screws or bolts 18 and secured by securing nuts 20.

A retaining plate 22 for holding the lens 28 has two screws 26 (though it could be more or less depending upon requirements) passing through the plate 22 and securable through two corresponding holes 30 in the gasket 32 and the mounting plate 34. The retaining plate 22 has two holes, or recesses, in the side of the plate that will face the mounting plate 34 so as to provide a flush mount against the heads of the securing screws or bolts 18.

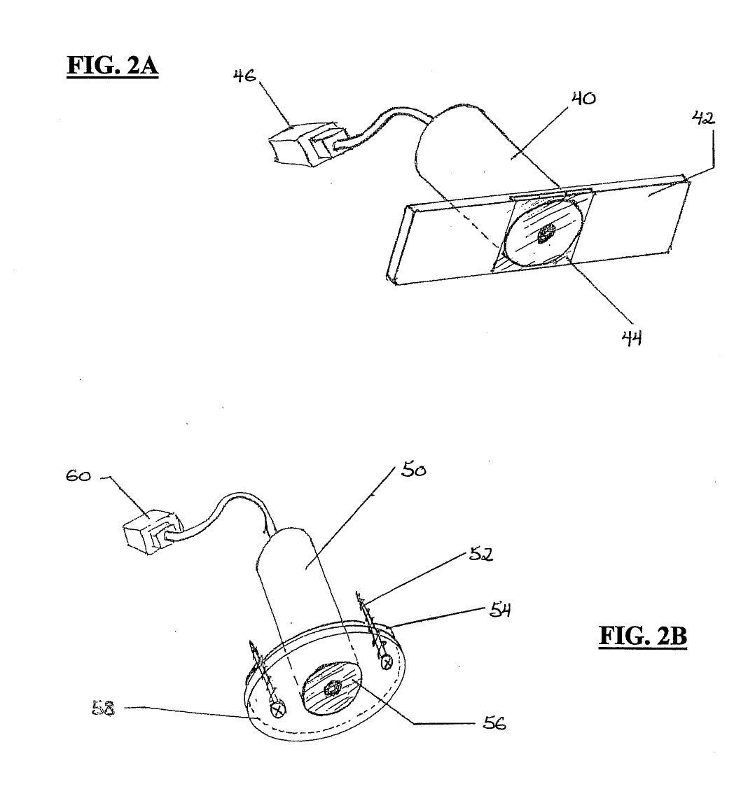

FIG. 2A is a perspective depiction of an alternative embodiment of the laser projection assembly 40 wherein the assembly is connected to a power line terminating in a male plug 46 which plugs directly into the power source of the door or vehicle. A puddle lamp lens 42, or comparable lens, is employed for ease of factory installation. The lens 42 supports a holographic diffraction grating or micro-lithograph of the image 44 to be projected.

A perspective depiction of an alternative embodiment of the laser projection assembly 50 is shown in FIG. 2B wherein the assembly is connected to a power line terminating in a male plug 60 which plugs directly into the power source of the door or vehicle. A universal mounting grommet 58 is employed to support a holographic diffraction grating or micro-lithograph of the image 56 to be projected.

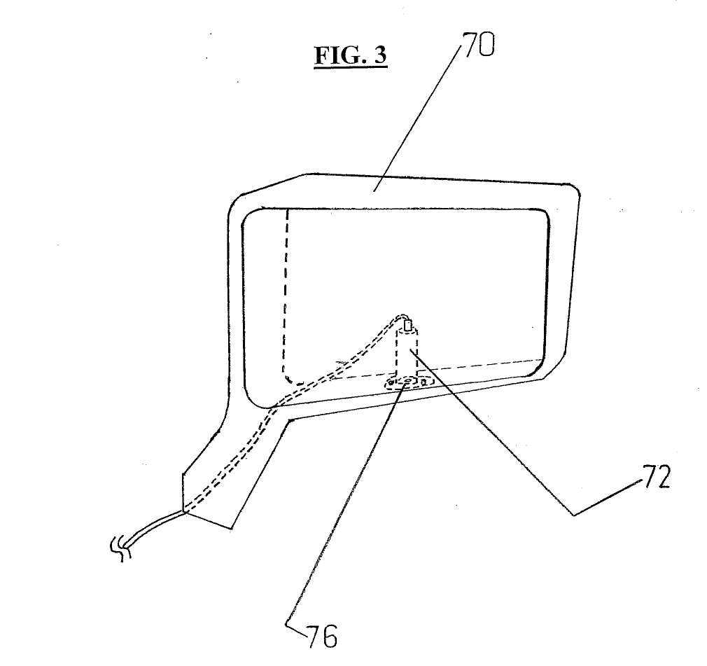

Turning next to FIG. 3, there is shown a perspective depiction of a vehicle side view mirror casing 70 with a laser projection assembly 72 mounted in the interior. The light beam is projected downward through the holographic diffraction grating or micro-lithograph 76 of the assembly and projects the image through the opening in the bottom of the side view mirror casing 70.

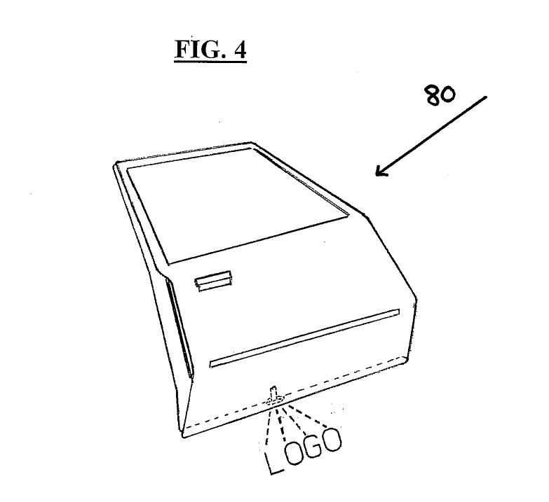

Mounting of the laser projection assembly can be done in any portion of the vehicle that allows the desired projection to be cast upon a desired surface. FIG. 4 is a perspective depiction of a car door panel 80 with the laser projection assembly mounted therein and casting the desired beam onto the street or curb.

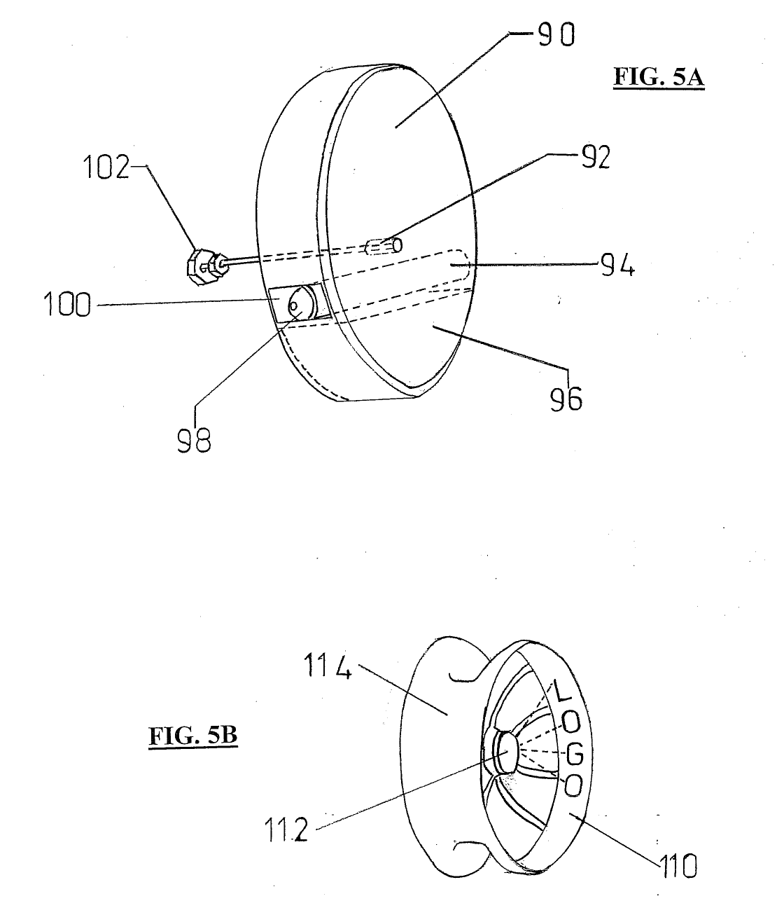

FIG. 5A is a schematic of a laser projection assembly 94 mounted within a carrier 90 and further mounted to the center cap of a wheel. The laser projection assembly 94 can be powered by the vehicle's power source or by a battery. The carrier 90 is mounted on a shaft 92 riding on ball-bearings or needle bearings. The shaft 92 is affixed to mounting hardware 102 which attaches through the center cap of the vehicle wheel. The carrier 90 has a loosely weighted bottom 96 so as to keep the laser projection assembly 94 in a stationary position as the wheel rotates. The output end of the laser projection assembly 94 faces a protective shield 98 to protect the device from environmental damage associated with wheel mounted hazards.

The cap mounted carrier 112 is mounted on a wheel 114 as is shown in FIG. 5B. The desired image is projected from the laser projection assembly 94 onto the rim of the wheel 114.

The adaptation of the present invention is not limited to cars. Any type of vehicle, with proximity to an appropriate surface could be used as a platform for the laser projection device. Vehicles, as contemplated herein, include, but are not limited to: cars; taxis; trucks; buses; airplanes; boats; motorcycles; and, recreational vehicles.

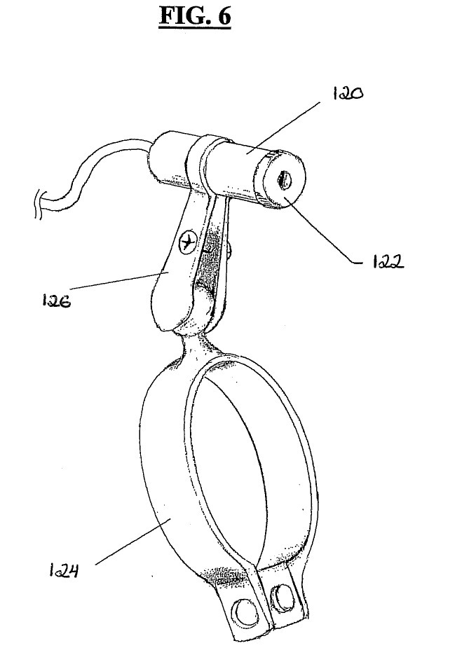

FIG. 6 is a perspective depiction of a clamp used to secure a laser projection assembly 120 having a holographic diffraction grating or micro-lithograph projection image 122 to motorcycle handlebars, or to the frame. A swivel clamp 126 with a ball joint secures the laser projection assembly 120 and allows for 360° rotation. The swivel clamp 126 is attached to a clamp 124 which is used to attach the entire clamp assembly to the handlebars or frame.

A laser projection assembly or assemblies 120 are mounted to the motorcycle and are connected to the motorcycle's power source. The laser projection assembly 120 will project a light beam through the holographic diffraction grating or micro-lithograph 122 onto the ground, curb, or other surface. For instance, an intermittent, flashing image of a turn signal arrow could be projected when the vehicle's standard turn signals are activated by the vehicle operator.

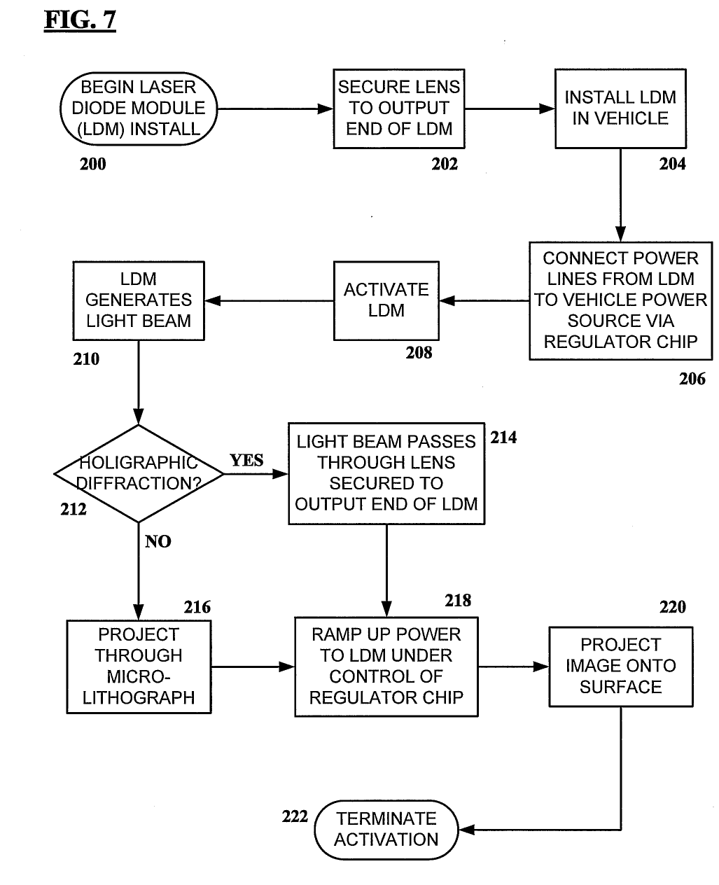

Bearing the apparatus and its various embodiments in mind, the method flow of the present invention is shown in the flowchart of FIG. 7.

The method flow is initiated at step 200 with preparation for installation of the laser diode module; or, in the alternative, a means for focusing a beam of light from pre-packaged or bare die LEDs, in a panel or portion of a vehicle such as a passenger car. The method flow advances to step 202 where the lens is secured to the output end of the laser diode module. It is contemplated that the lens or diffraction grating can be secured to the laser diode module prior to installation; but, in such a way as to allow for easy replacing of the image.

From step 202, the flow advances to step 204 where the laser diode module and it supporting assembly are mounted in the vehicle in a selected body panel. The power leads are connected during installation, at step 206, from the laser diode assembly to the vehicle power source. In the alternative, the assembly can be battery powered.

Once installed, the laser diode module can be activated, at step 208, upon direction from a switch within the vehicle. The switch can be movement triggered, as when a door is opened. Or, the switch can be tied into another activity such as with the employment of the turning signals or upon braking the vehicle. Alternatively, the image projection can be activated by an “on-off” switch under control of the vehicle operator or a passenger.

From step 208, the method flow advances to step 210 where the laser diode module generates a light beam. The light beam output operates within the range of 0 to 20 mW. As the beam is generated, the flow then queries as to whether or not the assembly lens is supporting a holographic diffraction image. If the response to the query is “YES”, then the flow advances to step 214 where the light beam passes through the lens secured to the output end of the laser projection assembly before advancing to step 218. However, if the response to the query at step 212 is “NO”, then the flow advances to step 216 where the light beam is projected through a micro-lithograph image before proceeding to step 218.

At step 218, the power to the laser diode module is ramped up under control of an in-line regulator chip. The power activating means (which includes the regulator chip and power source) operates so as to bring the light beam source up to full brightness from a zero state over a 2 second interval. A 10 second off-time is required in between start-ups of the power activating means for the zero state over a 2 second interval to occur.

The light beam causes the image on the diffraction grating or holographic diffraction to be projected, at step 220, onto the surface in the path of the beam. This can be accomplished by use of a collimated beam, shining through the holographic diffraction grating. The grating separates the laser beam, and redirects it, forming whatever image is determined by the grating. A second method is to simply shine a non-collimated laser beam through a micro-lithograph, or a negative image. The image blocks the light that is not required, and allows light to pass that is used to form the shape to be projected. The projection sequence is then terminated at step 222.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method for projecting an image from a vehicle onto a surface, said method comprising the steps of:
(a) installing a laser diode assembly in said vehicle;
(b) connecting a set of lines from said laser diode assembly to a power source of said vehicle, said set of lines for providing positive and negative current flow;
(c) securing a lens to an output end of said laser diode assembly, said lens comprising a light diffraction image; and
(d) activating said laser diode assembly so as to project a beam of light from said laser diode assembly through said lens so as to project said light diffraction image upon said surface.

2. The method of claim 1, wherein said installing step further comprises installing said laser diode assembly in a side view mirror assembly of said vehicle, wherein said laser diode assembly is within said side view mirror assembly and is positioned so as to project said light diffraction image through an opening, said opening located in a bottom portion of said side view mirror assembly and passing therethrough.

3. The method of claim 1, wherein said installing step further comprises installing said laser diode assembly in a door panel assembly of said vehicle, wherein said laser diode assembly is within said door panel assembly and is positioned so as to project said light diffraction image through an opening, said opening located in a bottom portion of said door panel assembly and passing therethrough.

4. The method of claim 1, wherein said securing step further comprises the step of mounting said lens on a plate and fixedly securing said plate to said output end of said laser diode assembly.

5. The method of claim 1, wherein said securing step further comprises the step of mounting said lens on a grommet and fixedly securing said grommet to said output end of said laser diode assembly.

6. The method of claim 1, wherein said vehicle is a motorcycle.

7. The method of claim 1, wherein said vehicle is an airplane.

8. The method of claim 1, wherein said activating step further comprises directing power from said vehicle power source to an inline regulator chip, said regulator chip for providing a voltage usable by said laser diode assembly.

9. The method of claim 2, wherein said activation step further comprises the step of initiating said activation by:
(a) switching on said laser diode assembly from a position within the interior of said vehicle; and
(b) ramping up said activation to a full-on state over a pre-set period of time.

10. The method of claim 3, wherein said activation step further comprises the steps of:
(a) opening a door of said vehicle wherein said vehicle door has said laser diode assembly mounted therein; and
(b) ramping up said activation to a full-on state over a pre-set period of time.

11. The method of claim 1, wherein said light diffraction image is a message projected upon said surface.

12. The method of claim 1, wherein said light diffraction image is a logo projected upon said surface.

13. The method of claim 1, wherein said light diffraction image is a graphic design projected upon said surface.

14. A system for projecting an image from a vehicle onto a surface, said system comprising:
(a) a laser diode assembly, said assembly further comprising a light beam source, and wherein said laser diode assembly is mounted on said vehicle;
(b) a power source;
(c) a power regulating chip;
(d) an image creation means, wherein said image creation means receives a beam of light from said light beam source and allows said beam of light to pass through said image so as to project said image upon a surface; and
(e) power activating means for causing said power to be introduced to said laser diode assembly so as to activate said light beam source.

15. The system of claim 14, wherein said laser diode assembly further comprises:
(a) a laser module;
(b) a spacer tube;
(c) a mounting plate; and
(d) a retaining plate.

16. The system of claim 14, wherein said light beam output operates within the range of 0 to 20 mW.

17. The system of claim 14, wherein said power activating means operates so as to bring said light beam source up to full brightness from a zero state over a 2 second interval.

18. The system of claim 14, wherein said image creation means comprises a micro-lithograph secured to said laser diode assembly, said micro-lithograph comprising an image thereupon.

19. The system of claim 14, wherein said image creation means comprises a coliminated beam, generated by said laser diode assembly, and shining through a holigraphic diffraction grating.

18. The system of claim 18, wherein said micro-lithograph is removably secured so as to be easily replaceable.

19. The system of claim 18, wherein said holigraphic diffraction grating is removably secured so as to be easily replaceable.

20. The system of claim 17, wherein a 10 second off time is required in between start-ups of said power activating means for said zero state over a 2 second interval to occur.

21. A method for projecting an image from a vehicle onto a surface, said method comprising the steps of:
(a) installing a laser diode module in said vehicle;
(b) connecting a set of lines from said laser diode assembly to a power source of said vehicle, said set of lines for providing positive and negative current flow;
(c) securing a lens to an output end of said laser diode assembly, said lens comprising a light diffraction image;
(d) directing power from said vehicle power source to an inline regulator chip, said regulator chip for providing a voltage usable by said laser diode assembly;
(e) activating said laser diode assembly, by switching on said laser diode assembly from a position within the interior of said vehicle, so as to project a beam of light from said laser diode assembly through said lens;
(f) ramping up said activation to a full-on state over a pre-set period of time; and
(g) projecting said light diffraction image upon said surface.

22. A method for projecting, from a vehicle, an image upon a surface, said method comprising the steps of:
(a) installing, in a panel of a vehicle, a laser projector assembly, said laser projector assembly having a distal end and a proximal end, said proximal end having a lens through which said image is projected, and wherein said laser projector is:
(i) programmable; and
(ii) has a power source;
(b) storing in a memory of said laser projector assembly said image;
(c) activating said laser projector assembly by causing said laser projector assembly to project said image upon a surface, said surface determined by the location of said lens.

23. The method of claim 22, wherein said power source is a battery resident within said laser projector assembly.

24. The method of claim 22, wherein said power source is a lead-in from said vehicle's power source.

25. The method of claim 22, wherein said laser projector assembly is capable of receiving an image download from a remote source.

26. The method of claim 22, wherein said panel is part of said vehicle's door.

27. The method of claim 22, wherein said activation step further comprises opening said car door to cause said laser projection assembly to project said image upon said surface.

28. The method of claim 22, wherein said surface is a street.

29. The method of claim 22, wherein said image is a fixed image.

30. The method of claim 22, wherein said image is a video image.
